(19) United States
(12) Patent Application Publication
(10) Pub. No.: US 2013/0337840 A1
(43) Pub. Date: Dec. 19, 2013

(54) DEVICES AND METHODS OF PROVIDING LOCATION BASED ALERTS

(71) Applicant: Infosys Limited, Bangalore (IN)

(72) Inventors: Vinay Singh, Zirakpur (IN); Prashant Sinha, Pune (IN)

(21) Appl. No.: 13/917,993

(22) Filed: Jun. 14, 2013

(30) Foreign Application Priority Data
Jun. 15, 2012 (IN) 2387/CHE/2012

(51) Int. Cl. H04W 4/02

(52) U.S. Cl. CPC H04W 4/02
USPC 455/456.3

(57) ABSTRACT

A method of generating alerts comprising the steps of receiving preference information to generate an alert indicating occurrence of an event, wherein the preference comprises location information of an event and determining location information of a mobile device. The location information is used for comparing the location information of the mobile device and the location information associated with the event. Subsequently generating an alert when the location information of the mobile device matches the location information associated with the event and based on the preference.

This application claims the benefit of Indian Patent Application Filing No. 2387/CHE/2012, filed Jun. 15, 2012, which is hereby incorporated by reference in its entirety.

### BACKGROUND

The present technique is in the field of portable device software. In particular, this invention relates to methods for providing location based alerts on mobile devices and devices thereof.

An alert, in general, is used on mobile devices by a user for a variety of applications to remind the user about an event or an appointment, for example, calendar appointments, to-do lists and clock alarms, the above mentioned alerts are based on events that are stored locally on the mobile devices. Alerts are used are becoming increasingly based on real world events that take place external to the mobile devices, for example, a retailer in the neighborhood announcing a time limited offer.

There is an increase in location awareness and networking capabilities built into the mobile devices. It is possible to utilize capabilities new mobile devices offer using the global positioning system along with other triangulation systems based on mobile phone base station signals.

Personalization is another aspect of user experience in mobile devices which can be improved using the availability of location information and using the preferences set by the user on the mobile device. Personalization can be achieved by using collaboration pattern among multiple users of a same mobile software application who generate content, for example, ratings and reviews of a product or place. This is also not currently used in delivering location based alerts to mobile users.

Therefore, there is a need for mobile devices to alert its user about external events and to deliver alerts to the mobile device user that are relevant and personalized to the needs and preferences of the end user.

### SUMMARY

Briefly described, the provided subject matter concerns, providing alerts on mobile devices for external events.

The present invention relates to a method of generating alerts on mobile devices including the steps of receiving preference information to generate an alert indicating occurrence of an event, wherein the preference includes location information about an event. The subsequent step is to determine the location information of a mobile device. After determining the location information of a mobile device, this location is compared with the location information associated with the event. Finally, an alert is generated when the location information of the mobile device matches the location information associated with the event and based on the preference.

The present invention also relates to a system for providing an alert based on location of a mobile device, the system includes a preference manager module configured to receive preference information to generate an alert indicating occurrence of an event, wherein the preference manager module stores the location of an event. The system also includes a location identifier module configured to determine the location information of a mobile device. The system uses a comparison module configured to compare the location information of the mobile device and the location information associated with the event. After comparison, the system uses an alerts module configured to generate the alert when the location information of the mobile device matches the location information associated with an external event and based on the preference.

### BRIEF DESCRIPTION OF DRAWINGS

These and other features, aspects, and advantages of the present invention will be better understood when the following detailed description is read with reference to the accompanying drawings in which like characters represent like parts throughout the drawings, wherein:

FIG. 1 shows an environment 100 in which the present invention can be practiced, in accordance with one or more embodiments.

FIG. 2 shows an environment 100 in which the present invention can be practiced, in accordance with one or more embodiments.

FIG. 3 shows a diagram detailing a database schema used by one or more embodiments.

FIG. 4 represents a flowchart describing the process involved in one or more embodiments.

FIG. 5 illustrates a generalized example of a computing environment 500.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

The present invention relates to a system, method and apparatus for providing location based alerts. Location information may include but is not limited to geographic coordinates, name of the place and meta-data that describes the location. Preference information may include but is not limited to rules for which an alert is generated and preference information is received from the mobile device user.

An alert system is used to create, manage and deliver alerts to a mobile device over a communication network. An alert is a text, voice or sound that is communicated to the user of a mobile device as a result of an event (e.g. arrival of a message or signal) or the occurrence of a condition (e.g. on entering a particular location) that was previously set. The system includes a mobile device that is used by a user to add or remove alerts, and a server connected over a communication for storing the user information and alert information. The mobile device communicates with the server using a data communication network. The mobile device also receives signals from global positioning system satellites or wireless mobile networks to determine the location of the mobile device.

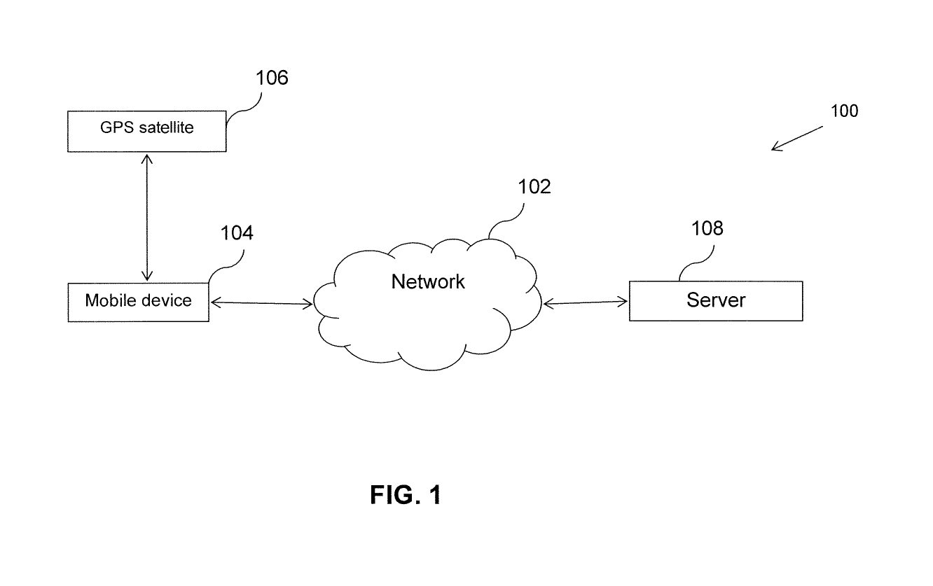

FIG. 1 shows an environment 100 in which the present invention can be practiced, in accordance with one or more embodiments. Environment 100 includes a mobile device 104, a communication network 102, a server 108 and global positioning system satellites (GPS) 106.

The server 108 stores geographic information associated with a particular location. Geographic information may include but is not limited to geographic co-ordinates of a location, name of the location, address of a location, and meta-data that corresponds to the location. For example, server may be a relational database server (e.g. MySQL, DB2) or a file server. The system also includes a mobile device 104 that communicates with the server 108. Examples of mobile devices include but are not limited to smart phones, personal digital assistants and touch enabled mobile devices. The mobile device 104 is connected to the server 108 using a communication network 102. For example, communication network may include but is not limited to local area network, wide area network, virtual private network and mobile wireless network. The location of mobile device 104 may be determined using global positioning system (GPS) 106.

In accordance with one or more embodiments, the mobile device 104 receives the preference information from the user that acts as rules when satisfied generate alerts. For example, when the preference is set to receive alert from a retail store for a time limited discount. The preference information is received at the mobile device 104 and is associated with a user of the mobile device and the preference information is stored on the server 108. The preference information may include but is not limited to the name of the alert, name of the retail store and location of the retail store. At any given time, the location information of the mobile device 104 is determined using the global positioning satellites using triangulation methods. This location information of the mobile device is then compared with the event location information stored on the server. When there is a match between the location of the mobile device and the location information of the event, an alert is generated and displayed on the mobile device 104.

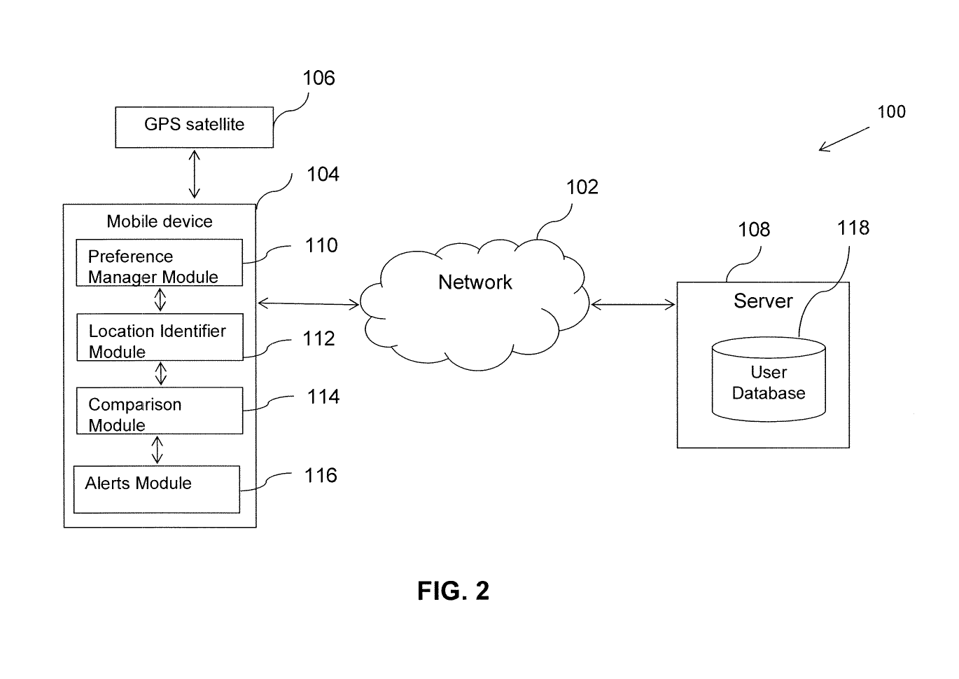

FIG. 2 shows an environment 100 in which the present invention can be practiced, in accordance with one or more embodiments. The mobile device 104 includes a preference manager module 110, location identifier module 112, comparison module 114 and an alerts module 116. The server 108 includes a user database 118 and communicates with the mobile device using a communication network 102.

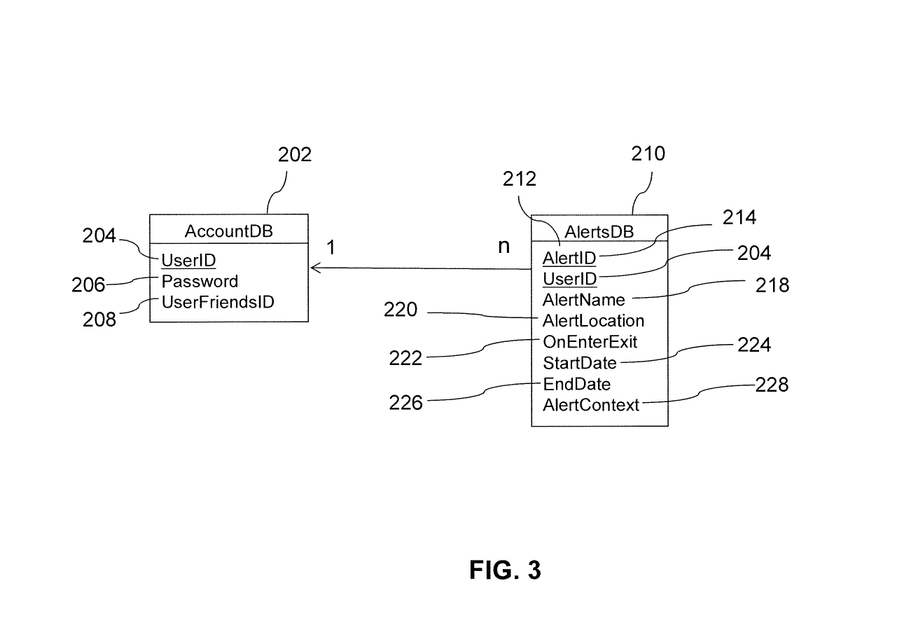

In accordance with an embodiment, the preference manager module 110 is used to receive and display the preference information about an event for which an alert will be generated on the mobile device 104. The preference manager module 110 communicates with the server 108, using communication network 102, which in turn is used to host the user database 118 and the preference information received at the server is stored in the user database 118. The information fields that are received and displayed by the preference manager module are described in the database represented by FIG. 3. The location identifier module 112 interfaces with the global positioning satellite receiver that is present in the mobile device 104. The comparison module 114 is used to identify a match between the location information of an event set using the preference manager module 110 and the location information of the mobile device. The comparison module 114 compares the geographic location information including latitude, longitude and elevation from the location information of the event and the location information of the mobile device 104. If result of comparison operation performed by comparison module 114 by identifying a match between location information of the event and location information of the mobile device 104, it passes the result of a successful comparison to the alerts module 116. The comparison module may also use approximate boundary regions for identifying a match between a mobile device location and a preferred location set for an event. The alerts module 116 interfaces with the mobile device operating system in order to generate a visual, audio or vibration alert, if the result of the comparison operation is an identified match.

FIG. 3 shows a diagram detailing the database schema used by one or more embodiments. The tables AccountDB 202 and AlertsDB 210 are tables that are present in a relational database on the server 108.

In accordance with an embodiment, the table AccountDB 202 is used to store the user information. Each user is assigned a unique row in the table AccountDB 202. The attributes of the table AccountDB are UserID 204, Password 206 and UserFriendsID 208. Each user is assigned a unique user identifier that is stored in the attribute UserID 204. Password corresponding to the UserID 204 is stored using the attribute Password 206. The table AccountDB 202 also contains a third attribute for each user that is UserFriendsID 208. The attribute UserFriendsID 208 is used to store multiple UserID values of other users who are connected to the user in an external social network (e.g. Facebook or Twitter). This information can be obtained using respective application programming interfaces (APIs) offered by external social networks.

The AlertsDB 210 is a table used to store information about the alerts for external events in the user database 118 present on the server 108. Each alert is assigned an unique identifier AlertID 214. The AlertsDB 210 table also stores the UserID 204, which represents the user who created the alert. The combination of AlertID 214 and UserID 204 will act as a primary key for the AlertsDB 210 table. The AlertsDB 210 table also stores the attributes AlertName 218 that represents the name of the alert set by the user, AlertLocation 220 that represents the geographical coordinates for the alert, OnEnterExit 222 that represents an indicator with text values “ENTER” or “EXIT” with the former indicating an alert on entering the geographical coordinates and the latter indicating an alert on exiting the geographical coordinates, StartDate 224 that stores the date from which the alert is active, EndDate 226 that stores the date when the alert expires, AlertContext 228 can take two values that are either “MYCONTEXT” or “OTHER” wherein the former indicates that the alert is to be made only to the user who added the alert and the latter indicates the alert is applicable to the users whose UserIDs are present in the UserFriendsID.

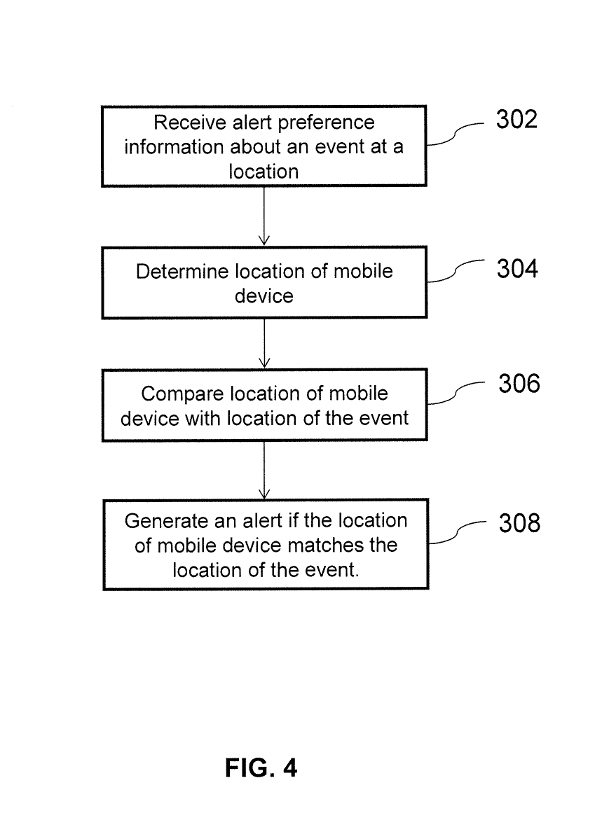

FIG. 4 represents flowchart describing the process involved in one or more embodiments. At step 302, in a preferred embodiment, the preferences for the location based alerts are received at the mobile device 104. The preferences are managed using the preference manager module 110 present on the mobile device, this module communicates with the server over a communication network to retrieve data from tables AccountDB 202 and AlertsDB 210 present in the server database. The preference manager module 110 receives input including but is not limited to fields present in the user database AccountDB 202 and alerts database AlertsDB 210. The preference manager module 110 receives preferences using an user interface on the mobile device 104 UserID 204, Password 206 and UserFriendsID 208. The user of the system is identified using the information present in the AccountDB 202 that is stored on the server 108. The preference manager module 110 uses a user interface which is displayed on a mobile device to receive the user name corresponding to the AccountDB 202 table attribute UserID 204, the password corresponding to AccountDB 202 table attribute Password 206 and the user names of the friends corresponding to the table attribute UserFriendsID 208. As described earlier UserID 204 is unique to the user and is used to identify the user of the system. Multiple UserID values may be stored in the UserFriendID 208 attribute of the AccountDB 202 table; these refer to the friends or contacts of a particular UserID 204. The preference manager module also performs the function of registering a new user to the system.

At step 304, the location identifier module 112 is used to identify the location of the mobile device 104 by using global positioning satellites 106 and at times connectivity to global positioning satellite systems are not available the location identifier module 112 may use wireless networks to identify the location of the mobile device 104.

At step 306, the comparison module 114 is used to compare the location of the mobile device 104 with all locations stored for alerts in AlertsDB 212. The location preference for an alert is stored in AlertLocation 220 of the AlertsDB 212 table. The comparison module 114 receives the location of the mobile device 104 from the location identifier module and uses the mobile device location to compare if any alerts in AlertsDB 212 correspond to the location of the mobile device 104, the comparison module may also use approximate boundary regions for identifying a match between a mobile device location and an alert preference location stored in AlertLocation 220. The comparison module may also verify other constraints set for an alert. The constraints include but are not limited to attributes OnEnterExit 222 identifies if the alert is to be generated on entering a location or exiting a location based on the presence values “ENTER” or “EXIT” respectively, StartDate 224 indicates the date and time when the alert is active, EndDate 226 indicates the date and time when the alert is inactive, AlertContext 228 indicates whether the alert is for the user associated with UserID or is for multiple values of UserID present in UserFriendsID. The comparison module 114 transmits the alert information to the alerts module 116 when the approximate location match is identified and the constraints are met.

At step 308, the alerts module 116 when it receives the alert information from comparison module 114 communicates with the mobile device 104 operating system application programming interfaces to generate a visual, a vibration or a sound alert. The alerts module may also depend on the settings already set on the mobile device 104 in order to generate alerts.

### Exemplary Computing Environment

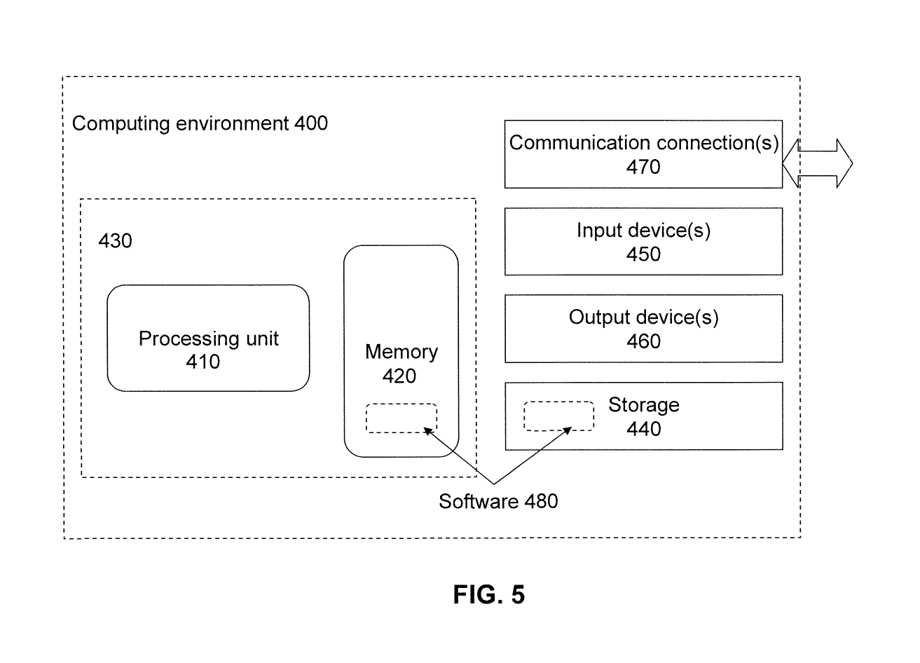

One or more of the above-described techniques can be implemented in or involve one or more computer systems. FIG. 5 illustrates a generalized example of a computing environment 400. The computing environment 400 is not intended to suggest any limitation as to scope of use or functionality of described embodiments.

With reference to FIG. 5, the computing environment 400 includes at least one processing unit 410 and memory 420. In FIG. 5, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

What is claimed is:

1. A method for generating alerts, the method comprising:
receiving, by an alert processing apparatus, preference information to generate an alert indicating occurrence of an event, wherein the preference comprises location information of an event;
determining, by the alert processing apparatus, location information of the alert processing apparatus;
comparing, by the alert processing apparatus, the location information of the alert processing apparatus and the location information associated with the event; and
generating, by the alert processing apparatus, an alert when the location information of the alert processing apparatus matches the location information associated with the event and based on the preference.

2. The method of claim 1 wherein the location information comprises geographic coordinates.

3. The method of claim 1 wherein the preference information comprises at least one of visual, audio or vibration notification for the alert.

4. The method of claim 2 wherein geographic area information associated with the location information is provided to a server for storage.

5. The method of claim 1 wherein the preference is associated with a priority.

6. The method of claim 1 wherein the location information is transmitted to a server using a network.

7. The method of claim 6 wherein the network is at least one of Internet, wireless mobile network or Wi-Fi network.

8. The method of claim 1 wherein the location information of the alert processing apparatus is determined using at least one of global positioning system (GPS), assisted global positioning system or wireless mobile network.

9. The method of claim 1 further comprises adding tag information to the location information.

10. The method of claim 1 further comprises sharing the alert information in a social network.

11. The method of claim 1 further comprising allowing searching for the alert using a mock location.

12. A non-transitory computer-readable medium storing instructions for causing a processor to provide an alert to a plurality of locations based on location of a mobile device, comprising:
a preference manager module configured to receive preference information to generate an alert indicating occurrence of an event, wherein the preference manager module stores the location of an event;
a location identifier module configured to determine the location information of an alert processing apparatus;
a comparison module configured to compare the location information of the alert processing apparatus and the location information associated with the event; and
an alerts module configured to generate the alert when the location information of the alert processing apparatus matches the location information associated with an external event and based on the preference.

13. The medium of claim 12 wherein the geographic area information associated with the location information is provided to a server for storage.

14. The medium of claim 12 wherein the location information determined by the location identifier module comprises geographic coordinates.

15. The medium of claim 12 wherein the preference information comprises at least one of visual, audio or vibration alert for the alert.

16. The medium of claim 12 wherein the preference is associated with a priority.

17. The medium of claim 12 wherein the location information is transmitted to the server using a network.

18. The medium of claim 17 wherein the network is at least one of Internet, wireless mobile network or Wi-Fi network.

19. The medium claim 12 wherein the location information of the mobile device is determined using at least one of global positioning system (GPS), assisted global positioning system or wireless mobile network.

20. The medium of claim 12 further comprises adding tag information to the location information.

21. The medium of claim 12 further comprises sharing the alert information in a social network.

22. The medium of claim 12 further allows search for at least one of the alert using a mock location.

23. A non-transitory computer readable medium having stored thereon instructions for generating alerts comprising machine executable code which when executed by a processor, causes the processor to perform steps comprising:
receiving preference information to generate an alert indicating occurrence of an event, wherein the preference information comprises location information of an event;
determining location information of an alert processing apparatus;
comparing the location information of the alert processing apparatus and the location information associated with the event; and
generating an alert when the location information of the alert processing apparatus matches the location information associated with the event and based on the preference.

24. An alert processing apparatus comprising:
a processor coupled to a memory and configured to execute programmed instructions stored in the memory comprising:
receiving preference information to generate an alert indicating occurrence of an event, wherein the preference information comprises location information of an event;
determining location information of the alert processing apparatus;
comparing the location information of the alert processing apparatus and the location information associated with the event; and
generating an alert when the location information of the alert processing apparatus matches the location information associated with the event and based on the preference information.
